(19) United States
(12) Patent Application Publication
(10) Pub. No.: US 2015/0088618 A1
(43) Pub. Date: Mar. 26, 2015

(54) ROAD TOLLING

(71) Applicant: IMS SOLUTIONS, INC., Schaumburg, IL (US)

(72) Inventors: Otman A. Basir, Waterloo (CA); William Ben Miners, Guelph (CA)

(21) Appl. No.: 14/556,977

(22) Filed: Dec. 1, 2014

Related U.S. Application Data
(60) Provisional application No. 61/870,219, filed on Aug. 26, 2013.

(51) Int. Cl. G07B 15/06; G07C 5/00

(52) U.S. Cl. CPC G07B 15/063; G07C 5/00
USPC 705/13; 701/1; 701/117

(57) ABSTRACT

A precision usage-based transportation infrastructure charging service includes a dynamic road and infrastructure usage engine that can fairly assess road usage based on any combination of mileage, time of day, vehicle mass, location, road class, defined zones and other relevant parameters. This flexible service leverages detailed vehicle driving information to generate road usage summaries, detailed validation data, and invoices or bills where appropriate. This service applies not only to movement along road networks, but also includes time-based and complex rules that support usage-based charging within parking lots, and usage-based charging based on per-person transportation efficiency and environmental impact.

### BACKGROUND

Road User Charging (RUC) schemes may have one or more of a variety of objectives. These might include: Reduction of congestion, to encourage a shift to other transport modes, emissions reduction, and revenue generation.

Most of these aims will be frustrated if there is widespread evasion of the scheme, however, in any scheme, to completely eliminate evasion is probably not a realistic proposition. Time-Distance-Place (TDP) road user charging schemes may have a number of factors that make 100% compliance with the scheme even more difficult to achieve. These factors include:

TDP schemes often cover a wide area, on more than just the major roads. Thus it is not realistic to cover all charged roads with on-street compliance checking equipment.

The ease of compliance checks to some degree depend on the type of OBE and back office systems, but compliance cross-checks are more complex than DSRC-based charging systems.

Privacy concerns may limit the amount of “tracking” data that can be gathered, both from the IVE and any compliance checking equipment, which may make cross-checking still more difficult.

There is great reliance on IVE security—an item that is in the hands of the user.

Some of the evidence of fraudulent activity or evasion that you may see may not be conclusive enough to impose a fine or penalty.

### SUMMARY

A Precision Usage-Based Transportation Infrastructure Charging service includes a powerful dynamic road and infrastructure usage engine that can fairly assess road usage based on any combination of mileage, time of day, vehicle mass, location, road class, defined zones and other relevant parameters. This flexible service leverages detailed vehicle driving information to generate road usage summaries, detailed validation data, and invoices or bills where appropriate. This service applies not only to movement along road networks, but also includes time-based and complex rules that support usage-based charging within parking lots, and usage-based charging based on per-person transportation efficiency and environmental impact. In scenarios where dynamic road tolling services are deployed, rules can be introduced to adjust for mass transit.

Precision Usage-Based Road Charging Services Cover Three Main Areas:

Flexible satellite-based road tolling

Precision road usage fees (HOT lanes)

Seamless and expedited parking

Flexible Satellite-Based Road Tolling

The service enables road tolling as a revenue tool without the need for traditional gantries and their relatively high capital and ongoing operational costs. The precision usage-based transportation infrastructure charging service leverages telematics to precisely assess vehicle location and movements through the road network to generate accurate invoices for each individual. Benefits of this approach include flexible application of rules both up front and throughout its operation. Examples include applying road tolling across all roads in a geographical area, application to only specific roads or road classes at specific times of day, and significantly more complex schemes to meet the unique needs of road tolling programs.

The entire road network can be tolled using this service, including accurately differentiating between in-state and out-of-state travel, in addition to separating between private and public roads. Invoice generation is integrated to charge each vehicle owner fairly based on their use of the public road network.

Precision Road Usage Fees (HOT Lanes)

Leveraging vehicle-based telematics enables fair road usage policies to be applied to virtually any road or road segment, including HOT lanes, without requiring investments in traditional infrastructure. In addition to distance-based charges, dynamic schemes are made possible to help manage congestion at peak times, or to introduce virtual gantries instantly with no additional maintenance requirements. While the precision of GNSS-based solutions on their own is insufficient to accurately identify individual lanes, the precision approach of this system augments GNSS information with relevant information from multiple sources to derive highly accurate paths for individual vehicles. Augmentation includes use of satellite and terrestrial data sources, the incorporation of internal vehicle movement sensors, and use of high precision 3-axis accelerometers.

Seamless and Expedited Parking

The precision usage-based road charging system can also be applied to both existing and new parking facilities to enable usage-based charging services that ensure travelers are charged fairly for their use of the parking infrastructure. This parking service is designed to deliver a seamless and convenient traveller experience while quickly and conveniently transitioning to or from mass transit. This Usage-Based Parking service includes a suite of reports, alerts, and monitoring tools to enable the rapid deployment of services across existing and new parking facilities. With this service, commuters can simply drive into the parking lot and enter into a building, board a train, or use another mode of transportation. No additional steps are introduced to ensure the time between modes of transportation is kept to an absolute minimum. This expedient transition is very important to ensure the driver remains focused on their journey, and does not need to be delayed or interrupted to wait in line for conventional tickets obtained from kiosks and placed on the dashboard. If the traveller is interested, online and mobile interfaces are used to access parking history, current charges, and to deliver relevant insights or constructive feedback.

Benefits for the Road Operator or Government Entity:

Reuse of existing wireless infrastructure to deliver road tolling services

Rapid creation or assignment of HOT lanes

Flexible rules available to introduce time of day, location, special events, and additional inputs into toll scheme

Improved flow of goods throughout transportation network

Simple compliance solutions

Benefits for Drivers:

Elimination of delays associated with traditional parking meters

Accurate trip logs available for work and personal use

Improved performance and productivity with actionable feedback

Realtime remote emissions monitoring available

Insurance reduction opportunities

Additional services available (maintenance, second-by-second details, . . . )

A system objectively assesses transportation infrastructure usage by measuring or obtaining one or more parameters describing vehicle usage, driving, vehicle occupants, environmental, and infrastructure impact. The transportation infrastructure usage assessment may be configurable before and/or after deployment to assess usage using static or dynamic rules. The vehicle driving information may include, but is not restricted to, idling time, emissions, mileage, time of day, vehicle mass, location, road class, vehicle class, and defined zones. The road usage information may be transformed into a usage fee or toll. Fees may include, but are not restricted to, flexible gantry-free road tolling, precision road usage fees, and seamless and expedited parking.

The usage fees for services may be delivered to the vehicle owner by generating transportation infrastructure usage summaries, detailed validation data, and invoices/bills with objective evidence to support each usage fee. The individual usage information is validated using aggregate vehicle movement information, vehicle movement information from vehicles in close proximity to the vehicle in question, and/or infrastructure reference points. The precision road usage fee can be applied on individual lanes or lane segments. Precision road usage fees are realized by identifying individual lanes using precise absolute and/or relative location data and computing fees using static or dynamic rules. The rules may include the total number of occupants within the vehicle. The dynamic road usage fee computation rules may include exceptions for emergencies and emergency vehicles (police, ambulance, firetruck, towtruck). The dynamic rules may include time-varying parameters such as traffic congestion peak times, and recent traffic load estimates. The precision location information may obtained through augmenting vehicle location observations with relevant information from one or more external sources including, but not restricted to, satellite and terrestrial data sources, internal vehicle movement sensors, and high-precision 3-axis accelerometers.

The expedited parking service may be realized through identifying the time and duration where the vehicle location rests within known parking zones and applying static or dynamic parking fee rules. The static parking fee rules may be those which are provided a priori for one or more parking zones/lots based on time of day, road class, season, and vehicle size. The dynamic parking fee rules may include a factor to compensate for (or encourage) the use of mass transit.

A system validates road usage compliance by automatically obtaining and cross referencing license plate details on restricted use lanes against location data reported from the vehicle. The flow of goods may be optimized throughout a transportation network by dynamically adjusting transportation infrastructure usage fees with the intent of modifying driving patterns. The system may dynamically create, remove, or expand dedicated restricted-use lanes (i.e. HOT lanes) to optimize the flow of traffic based on historical, current, and predicted vehicular travel.

The system may minimize aggregate emissions by dynamically adjusting transportation infrastructure usage fees to influence transportation decisions. The transportation infrastructure usage fee information may be conveyed to the traveller as an estimated total journey cost during route planning and/or dynamically while in transit.

The number of occupants may be manually specified for each journey. The number of occupants may be automatically determined using an occupant detection system. The occupant detection system obtains cues from one or more personally identifiable sources to infer total occupants and/or the identity of occupants. Sources may include the presence of phones, RF emitting devices, and/or passive RFID elements within personal items (i.e. credit cards).

The transportation infrastructure impact may be delivered to the traveller in advance of, or during the planning of their journey to support informed travel decisions based on expected infrastructure usage charges, environmental impact, travel time, and other characteristics.

The fee rules may be structured in the form of virtual gantries to simulate the same behavior as traditional gantry-based road tolling. The most likely number of occupants may be determined based on context, location, or historical usage patterns. The default number of occupants can be specified in advance, and overridden as required on a journey by journey basis. The number of occupants can be specified as one, two, or more.

### BRIEF DESCRIPTION OF THE DRAWINGS

FIG. 1A is a schematic of telematics hardware that could be used to implement the road tolling system.

FIG. 1B is a schematic of a security implementation of the road tolling system.

FIG. 2 is a schematic of roadside compliance checks for the road tolling system.

FIG. 3 is a schematic of the road tolling system.

FIG. 4 is a schematic of the telematics platform major components.

FIG. 5 schematically shows the data flow of the telematics platform.

FIG. 6 schematically shows the telematics platform architecture.

FIG. 7 shows example charging and billing schemas.

FIG. 8 shows access to the Road User data storage through a secure web portal.

FIG. 9 shows example charge processing.

FIG. 10 shows example charging and billing schemas.

FIG. 11 shows an example scheme 1 travel pattern.

FIG. 12 shows an example scheme 2 travel pattern.

FIG. 13 shows an example of charge classes.

### DETAILED DESCRIPTION

How a Compliance Checking System may Operate.

The choice and extent of compliance checking operations will to a large degree depend on the compliance strategy adopted. However it is worth listing the types of tools and systems that may be available to the compliance checking team.

IVE Security

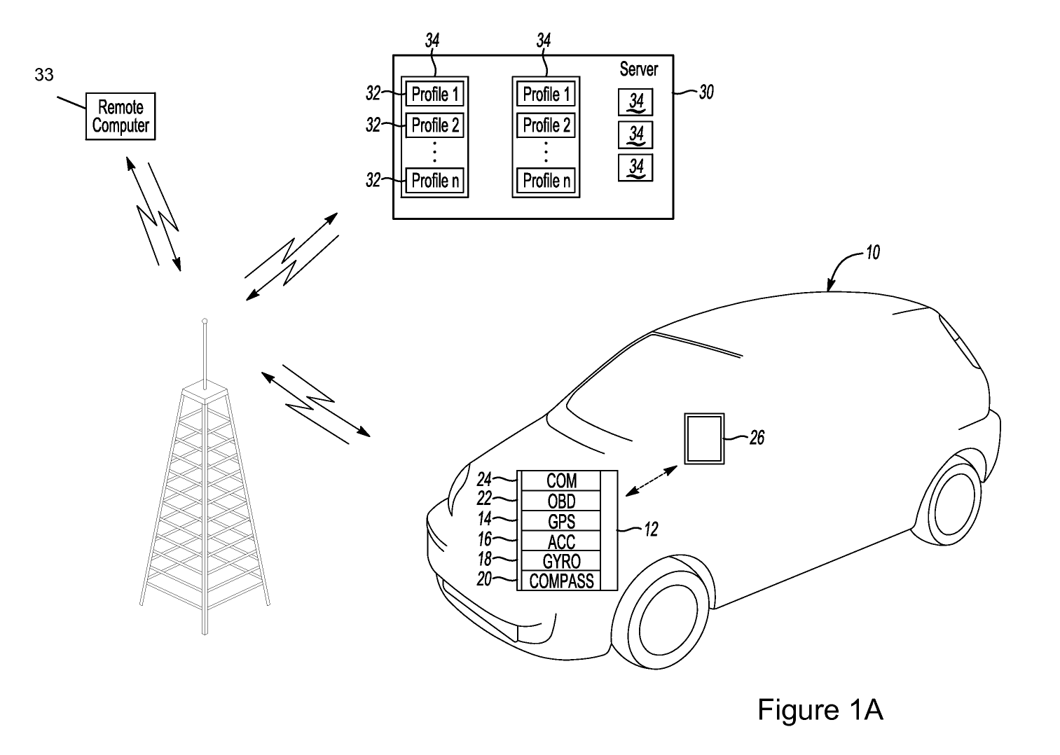

This is the most important part of the compliance checking system—the IVE 12 being able to prevent and detect potential fraudulent activity itself. There are three main ways as shown in FIG. 1B that the OBE may indicate such fraudulent activity:

Visible on the IVE 12 itself, through an electronic fault/tamper indicator, or tamper evident hardware.

Reporting of event data over the long-range communications.

Responding to a DSRC interrogation when passing some roadside compliance checking equipment.

Referring to FIG. 1A, a motor vehicle 10 includes a plurality of data gathering devices that communicate information to an appliance (IVE) 12 installed within the vehicle 10. The example data gathering devices include a global positioning satellite (GPS) receiver 14, a three-axis accelerometer 16, a gyroscope 18 and an electronic compass 20, which could be housed within the appliance 12 (along with a processor and suitable electronic storage, etc. and suitably programmed to perform the functions described herein). As appreciated, other data monitoring systems could be utilized within the contemplation of this invention. Data may also be collected from an onboard diagnostic port (OBD) 22 that provides data indicative of vehicle engine operating parameters such as vehicle speed, engine speed, temperature, fuel consumption (or electricity consumption), engine idle time, car diagnostics (from OBD) and other information that is related to mechanical operation of the vehicle. Moreover, any other data that is available to the vehicle could also be communicated to the appliance 12 for gathering and compilation of the operation summaries of interest in categorizing the overall operation of the vehicle. Not all of the sensors mentioned here are necessary, however, as they are only listed as examples.

The appliance 12 may also include a communication module 24 (such as cell phone, satellite, wi-fi, etc.) that provides a connection to a wide-area network (such as the internet). Alternatively, the communication module 24 may connect to a wide-area network (such as the internet) via a user's cell phone 26 or other device providing communication.

The in vehicle appliance 12 gathers data from the various sensors mounted within the vehicle 10 and stores that data. The in vehicle appliance 12 transmits this data (or summaries or analyses thereof) as a transmission signal through a wireless network to a compliance back-office application on a server 30 (also having at least one processor and suitable electronic storage and suitably programmed to perform the functions described herein). The server 30 utilizes the received data to determine where and how the vehicle 10 is being driven. For example, driving events and driver behavior are recorded by the server 30, such as fuel and/or electricity consumption, speed, driver behavior (acceleration, speed, etc.), distance driven and/or time spent in certain insurance-risk coded geographic areas, distance drive and/or time spent/time of day/day of the week on certain roads or lanes, etc. For example, the on-board appliance 12 may record the amount of time or distance in high-risk areas or low-risk areas, or high-risk vs. low risk roads. The on-board appliance 12 may collect and transmit to the server 30 (among other things mentioned herein): Speed, Acceleration, Distance, Fuel consumption, Engine Idle time, Car diagnostics, Location of vehicle, Engine emissions, etc.

The server 30 includes a plurality of profiles 32, each associated with a vehicle 10 (or alternatively, with a user). Among other things, the profiles 32 each contain information about the vehicle 10 (or user) including some or all of the gathered data (or summaries thereof), payment information, payment history, etc. Some or all of the data (or summaries thereof) may be accessible to the user via a computer 31 over a wide area network (such as the internet) via a portal, such as fuel efficiency, environmental issues, location, maintenance, etc. The user can also customize some aspects of the profile 32.

It should be noted that the server 30 may be numerous physical and/or virtual servers at multiple locations. The server 30 may collect data from appliances 12 from many different vehicles 10 to use the Road Charging Scheme. The server 30 permits each user/owner to access only his own profile 32 and receive information based upon only his own profile 32.

The server 30 may not only reside in traditional physical or virtual servers, but may also coexist with the on-board appliance, or may reside within a mobile device. In scenarios where the server 30 is distributed, all or a subset of relevant information may be synchronized between trusted nodes for the purposes of aggregate statistics, trends, and geo-spatial references (proximity to key locations, groups of drivers with similar driving routes).

Independent of the particular underlying hardware, driving locations, times (etc) and driving behavior are derived and collected. Compliance may be monitored by roadside equipment 36.

Roadside Compliance Checks

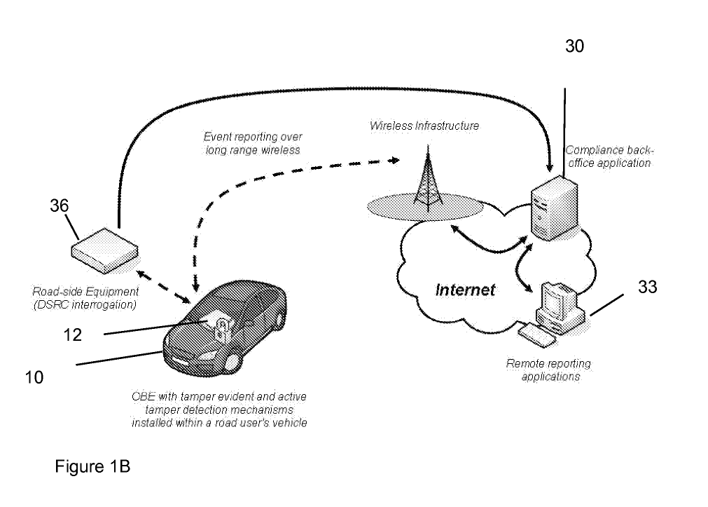

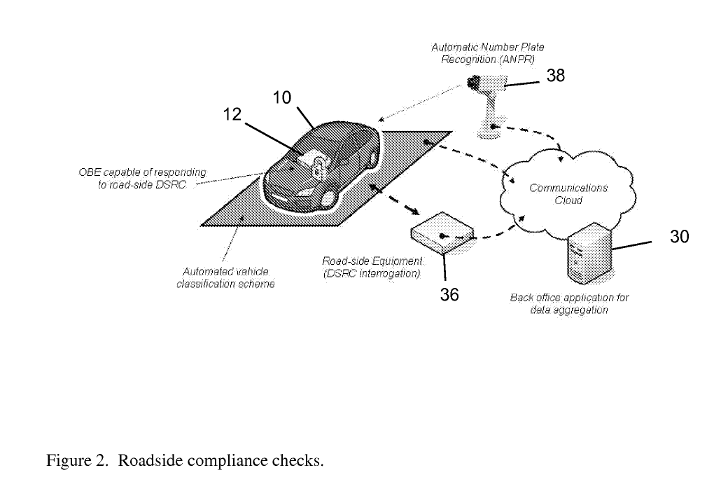

Referring to FIG. 2, the present system provides roadside compliance checks. For a TDP system, it is likely that the roadside equipment (RSE) 36 will detect some or all of the following as illustrated in FIG. 2.

DSRC—the IVE 12 would normally have a facility to respond to interrogation by a DSRC system with a specific compliance checking message.

The system may also include an Automatic Number Plate Recognition (ANPR) system 38 having a camera for reading the vehicle license plate. This of course relies on the security of the vehicle number plate.

Vehicle classifier. The benefit or use of a vehicle classifier depends very much on the details of the scheme. If there are different charges or exemptions for different classes of vehicles, and these classes can be detected by some sort of on-road measurement, then a classifier provides a useful cross-check to other data.

The present system links all of the above data from the same vehicle 10 together, with a very high degree of accuracy. For some types of roadside equipment 36 and traffic conditions, this may be quite challenging. It is usually necessary in high traffic flow conditions to have some sort of spatial overlap between the capture zones of the three types of equipment.

Roadside compliance checking equipment may take several forms:

Fixed equipment—mounted on a gantry or pole. All of the above equipment is mounted over the lane(s) to be monitored. System is unattended in use.

Transportable equipment—as fixed equipment, but demountable to move from site to site. This could also cover trailer-mounted equipment. Again, system is unattended in use.

Mobile equipment—this is equipment that is vehicle-mounted, and is used either while the vehicle is moving, performing checks on other moving vehicles, or may also be used while the vehicle is stopped at the roadside, for checking passing vehicles. System is attended in operation.

Hand-Held equipment—this is equipment for a compliance officer on foot to conduct compliance checks on a stationary vehicle. This could be in parking lots, or as a part of a stop-team operation (see below).

Stop-team equipment—if it envisaged to run stop teams to stop a targeted or random selection of vehicles, consideration needs to be given to equipment they might need to select suspicious vehicles, and what they would do after vehicles are stopped.

Back-Office Processes

A compliance back office system is essential for any compliance system. This may be a part of the wider charging and payments back office on server 30, or a separate, but linked system. Functions might include: Monitoring and control of all road side equipment 36, automatic number plate recognition 38. Reception and processing of events data from IVE 12. Reception and processing of data from the road side equipment 36. Holding and updating various databases used for data mining cross-checks.

Data mining—using data from a number of different sources to cross-check and look for inconsistencies.

Preparation of outputs when suspicious or fraudulent activity is detected (e.g. penalty charge notice, warning letter etc).

Safeguards and Security Features Built into the IVE

Any TDP charging scheme relies very heavily on the basic security of the IVE 12. A range of safeguards and security features are integrated within the IVE 12, from power interruption through to data integrity measures and movement detection. Features included in IVE 12 units include:

Power Interruption

Each power disconnection and reconnection event is logged internally to ensure information about the duration and approximate location of disconnection is available for further analysis. Logs are queued for transmission to the back office systems (e.g. server 30) on subsequent connection.

SIM Removal

The removal or replacement of a SIM card (e.g. communication device 24; FIG. 1) is detected by the IVE 12 and logged as a tamper event. The IVE 12 is paired with a specific SIM card during provisioning and deployment. Any discrepancies between the IVE 12 serial number and the SIM card are logged for further analysis. This information will be queued for transmission to the back office systems once the original SIM card is re-inserted.

VPN

A virtual-private-network is used to maintain transport security between the IVE 12 and the back office systems 30. This approach leverages a mature and proven encrypted tunnel to deliver information between the WE 12 and back office systems 30 without intermediate eavesdropping or tampering opportunities.

Data Integrity

Positional and vehicle information is collected and stored in a manner to ensure internal adjustments to individual data elements are detected. Over time, additional positional and vehicle information is stored in separate segments or blocks. Each block is associated with its predecessor and successor to help ensure all blocks are successfully transmitted and received. Missing blocks are reliably detected, in addition to missing or tampered elements within blocks.

Movement Detection

The IVE 12 automatically powers up when movement is detected (e.g. by accelerometers 16). This feature ensures the IVE 12 continues to collect relevant positional and vehicular information even if a method is employed to tamper with the power signal to prevent reliable ignition detection/engine running.

Antenna Tampering

Active antennas are deployed with the IVE 12, allowing the presence or absence of an antenna to be detected. If an antenna is removed or disconnected, the time and approximate location of the disconnect and subsequent reconnect is logged for future analysis. Shielded or blocked antennas are detected using alternate complementary sources of information (e.g. accelerometer 16 and OBD-II 22)

Accelerometer

The 3D accelerometer 16 is available for a range of applications, including waking up the IVE 12 when motion is detected. When combined with the power signal analysis to determine engine status and positional sensors, the additional accelerometer information provides a secondary source to identify: Vehicle movement without engine running (vehicle towing/stolen vehicle) or Vehicle movement with jammed/blocked GPS 14 signal.

OBD-II Based Safeguards

Information from the OBD-II 22 interface provides complementary information to augment existing GPS 14 and accelerometer 16 sensors within the IVE 12. The additional OBD-II 22 information provides another reference to verify consistency and validity of sensor information.

With sufficient effort, it is possible to tamper with the positional data before it reaches the IVE 12. This is possible in cases where the real GPS signal is replaced with a simulated signal using a nearby external GPS transmitter. The local GPS transmitter can be configured to provide a consistent signal to trick any nearby GPS receiver 14 into recording a stationary position (no movement). Fortunately, additional data from the OBD-II interface 22 provides an independent source of movement information. The vehicle speed sensor (VSS) from the OBD-II 22 is not susceptible to the same tampering method. Significant discrepancies between the VSS and GPS 14 based information will exist in scenarios of fraud via GPS signal tampering.

Supplemental OBD-II Information

In addition to the vehicle speed sensor (VSS) from OBD-II 22, other vehicle characteristics will be leveraged to further improve the security of the overall system. These characteristics include fuel consumption, level, and vehicle emission status and configuration. Large discrepancies in these characteristics are indicative of vehicle travel without an IVE 12, movement of the IVE 12 from one vehicle to another, or attempted tampering of OBD-II information before it reaches the IVE 12.

Internal Battery

An internal battery is designed into specific variants of the WE 12 to support data collection and event generation even while disconnected from the vehicle 10. This feature is valuable to characterize behavior after removal from the vehicle 10, or while attempted fraudulent activity is in progress.

Hybrid Internal/External Antennas

A variant of the IVE is planned with multiple antennas (both internal and external). Use of multiple antennas is valuable to ensure GPRS connections and GPS reception is possible even if a portion of the available antennas are blocked or shielded. The switching between internal and external antennas will be handled automatically by the embedded software residing on the IVE. Events that may require a switch between the external and internal antenna may include the removal or shield of the external antenna, tampering of external antenna or the malfunction of either antenna.

Jamming Detection

The GPS receiver 14 is capable of detecting jamming. Jamming is usually defined as a RF signal that either intentionally or unintentionally interferes with the reception of GPS signals. The GPS receiver's sensitivity and filtering can help overcome interfering RF signals and allow the reception of GPS signals necessary to provide navigational data.

Enclosure Breach Detection

Active detection of breaches of the enclosure of the WE 12 may be used. When the enclosure is detected to be opened, a message would be stored on the IVE 12 and forwarded to the server 30 over the long-range wireless connection when available.

Informing the Scheme Operator

Some of the above features are aimed at making fraud more difficult, and some are aimed at alerting the scheme operator to suspicious activity.

There are two main ways of the IVE 12 informing the scheme operator.

Event messages sent over the normal long-range communications system 24 (GPRS or similar). This of course relies on that communication channel being open, and not in itself subject to tampering. Error status within a DSRC transaction seen by roadside equipment 36. This of course requires the vehicle 10 to pass such equipment. As each method has shortcomings, the combination of both techniques is the optimal solution.

Informing the Driver

There are a range of possible feedback media and techniques for the driver, and a range of possible information that could be imparted. For the purposes of this report, the emphasis will be on information that has compliance implications.

It may be important to inform the driver of certain events. For example if there is an obligation for the driver to have faulty IVE 12 repaired within a certain timescale, there must be some visible or audible indication that the equipment is faulty. If a driver is to be penalized for not having the IVE 12 repaired within the required timeframe, then some positive confirmation that the information indicator was in fact set and working may be needed.

If a driver notices that every time they drive past a certain spot, they lose GPS lock, it may give a clue that there is a source of interference locally.

It may also be useful to have an indication of when a high-charge area is being approached, or a high tariff time is approaching. This may reduce appeals against such charges, and also remove any arguments the user did not know of the high charges. Set against this, one must consider that such a warning may open up the authority to a claim that the IVE 12 did not indicate a high charge area, and so they should not pay.

Listing of Fraud Vs Detection Mechanism

This section looks at the mechanisms for detection of fraud, and attempts to classify the generic types of compliance checks.

Fraud Vs Detection

The following is a list of some types of fraud, and the possible detection mechanisms. This is not intended to be an exhaustive list, as no doubt fraudsters will think of new ways to try to beat the system. It is also a fairly broad categorisation of potential fraud, and so by its nature, there may be specific examples of the fraud category that would not be detected by the proposed measures.

Also the listing does not address the measures taken to make the fraud more difficult in the first place. WE 12 related measures of this type are discussed above. As an example, shielding the GPS antenna will be made more difficult by the use of multiple antennas, however this section assumes the fraudster has been successful, and how this may be detected.

The final column of this table lists possible alternative (usually innocent) explanations for the symptoms seen. This will control the options available to the operator once possible fraud has been detected.

| | | Possible CC | What scheme | Possible alternative |
|---|---|---|---|---|
| | | detection | operator sees | explanation for |
| Fraud Title | Fraud Description | mechanisms | (symptoms) | symptoms |
| IVE | Power supply is | 1. No IVE | ANPR read for non- | Faulty IVE |
| disconnected | removed from IVE, or | detected when | exempt vehicle with | |
| | IVE is removed from the | passing on-street | no DSRC | |
| | vehicle | enforcement | transaction. | |
| | | 2. Power | Event message sent | Service battery |
| | | disconnect | back by battery | disconnection, Low |
| | | detection | power. Possibly | vehicle battery power |
| | | | linked to | Faulty IVE |
| | | | accelerometer or | |
| | | | speed detection. | |
| GPS Antenna | User disconnects the | 1. Antenna | Antenna disconnect | Accidental |
| Disconnected | GPS antenna to prevent | disconnect event | event | disconnection. |
| | location detection | logged | | |
| | | 2. Accelerometer/ | Event logged that | Low GPS signal (e.g. |
| | | speed detection | speed/accelerometer | in an underground car |
| | | | movement detected | park). |
| | | | with no GPS | |
| | | | movement | |
| | | 3. DSRC | Actual and reported | Accidental |
| | | transaction at | location varies as an | disconnection. |
| | | enforcement site | enforcement site is | Low signal area |
| | | | passed. | Faulty IVE |
| GSM antenna | User disconnects the | 1. Antenna | Antenna disconnect | Faulty IVE |
| Disconnected | GSM antenna to prevent | disconnect | event is logged, but | |
| | location, charging or | detection | can only be received | |
| | event data being sent in. | | when the GSM is re- | |
| | | | connected, or by | |
| | | | DSRC at an | |
| | | | enforcement site. | |
| | | 2. Roadside | Roadside equipment | Faulty IVE |
| | | detection - | detects vehicle, but | Low GSM signal |
| | | charge event | no charge data is | External jamming of |
| | | | received. Note - this | GSM |
| | | | approach differs for | |
| | | | thin and smart client | |
| | | | approaches. | |
| GSM | Feeding the GPS system | 1. Roadside | Roadside equipment | Faulty IVE |
| Beaconing | with a false signal that | detection - | sees a difference in | Poor GPS signal |
| | makes it think its | positional data | actual and reported | |
| | position is static, or | | position | |
| | distance travelled is less | 2. Minimum | If a vehicle is seen at | Faulty IVE (but |
| | than reality. | distance check | several enforcement | unlikely). |
| | | | sites, a minimum | Note - there may be |
| | | | possible distance can | privacy issues |
| | | | be calculated and | associated with this |
| | | | compared to the | approach. |
| | | | charge data. Note - | |
| | | | this is particularly | |
| | | | applicable to smart | |
| | | | client solutions | |
| | | | where no positional | |
| | | | data is passed back. | |
| IVE vehicle | An IVE is swapped from | 1. Roadside | ANPR and DSRC | Mismatched at the |
| swap | one vehicle to another. | equipment check. | transaction vehicle | roadside (may need to |
| | This would normally be | | ID do not match. | look at more than one |
| | a low-tariff IVE | | | record) |
| Fraud Title | Fraud Description | Possible CC | What scheme | Possible alternative |
| | | detection | operator sees | explanation for |
| | | mechanisms | (symptoms) | symptoms |
| | swapped to a higher | | | Incorrect data in IVE |
| | tariff vehicle. | 2. Class detection | Roadside equipment | Incorrect vehicle class |
| | | | detects a different | detection or matching |
| | | | vehicle class than | of class data to the |
| | | | that expected from | DSRC data. |
| | | | the IVE data. | |
| IVE hack | This s very generic | 1. Internal IVE | A tamper event from | Faulty IVE |
| | category covering some | security will | the IVE. | Service work giving a |
| | sort of interference with | detect fraud | | tamper alarm |
| | the OBE. More likely | through its | | |
| | on “smart client” IVE | internal detection | | |
| | where the position is not | mechanisms. | | |
| | reported back routinely, | 2. Minimum | If a vehicle is seen at | Faulty IVE |
| | as there are more | distance check | several enforcement | |
| | opportunities to | | sites, a minimum | |
| | manipulate the data. | | possible distance can | |
| | | | be calculated and | |
| | | | compared to the | |
| | | | charge data. | |
| | | 3. Data mining - | Cross referencing | Faulty IVE |
| | | cross checks | charge data with | External jamming of |
| | | | other sources of | GPS |
| | | | location or distance | |
| | | | data e.g. annual | |
| | | | MOT test odometer | |
| | | | readings. | |
| | IVE jamming | 1. Roadside | Roadside equipment | |
| | | detection - | sees a difference in | |
| | | positional data | actual and reported | |
| | | | position | |
| | | 2. Accelerometer/ | Event logged - speed/ | |
| | | speed detection | accelerometer | |
| | | | movement detected | |
| | | | with no GPS | |
| | | | movement | |

Classification of Compliance Checks

In looking at the specific examples of fraud detection through Compliance Checking, it becomes apparent that the types of compliance checks can be broken down into a number of classifications:

| Class | Trigger event | Example | Comment |
|---|---|---|---|
| 1. IVE reporting | Event generated | GPS antenna disconnect | Usually relies on GSM to |
| | ion IVE | alarm. | transmit to operator. |
| 2. Roadside | Record from | ANPR/DSRC | Has the possibility that if |
| Equipment (RSE) | vehicle passing | mismatch (IVE in wrong | checks prove negative at the |
| detection | RSE | vehicle) | roadside, data need never be |
| | | | sent to the back office so |
| | | | guarding privacy. |
| 3. RSE to Back | Record from | Minimum distance | Relies of CBO data being |
| Office (CBO) | vehicle passing | checks | available at the roadside, or all |
| checks | RSE | | data being bought back to the |
| | | | CBO. Some countries regard |
| | | | the latter as contrary to privacy |
| | | | policy. |
| 4. CBO to CBO | Availability of | MOT odometer - | Sources of alternative data may |
| checks (“data | new data. | comparison to charge | be more for commercial trucks |
| Mining”) | Periodic random | records. | than for private vehicles. For |
| | checking | | example additional data may be |
| | | | available from VOSA for these |
| | | | vehicles, also delivery route |
| | | | and destination details may be |
| | | | available. |

Options on Detection of Fraudulent Activity

Once a suspicious activity or cross-check is detected, the scheme operator must decide what action(s) to take. This must be heavily influenced by the compliance strategy that is being pursued.

Action Options

The following is a list of seven options for action on detection of suspicious activity or cross-check.

a) Do nothing—data is deleted, if for example the indications are weak, and there are other, higher priorities in the data received.

b) Hold data and wait for further evidence—where there is low level suspicion, but not yet enough evidence for more definite action.

c) Hold data and instigate further checks—as above, but further checks are actively instigated. This might be further cross checks with external data sources, or a minimum distance plausibility checks.

d) Put on a stop-team list—normally this would only be worthwhile if suspicious activity has been detected and:
The stopping officer may be able to gather further evidence by inspection of the vehicle or installation;
The address of the vehicle owner is unknown (e.g. not correctly registered with DVLA, or could be an overseas vehicle); or
The owner has not paid existing penalties.

e) Send the owner a warning letter—this could indicate that something outside the normal has happened, and asking them to please ensure that everything is unobstructed etc (i.e. list best practice). The letter would have no legal significance or penalty. It is simply to deliver the message that they have been detected.

f) Compel the vehicle owner to have the IVE 12 checked/replaced by a registered installer.

g) Impose a penalty charge or fine on the owner.

One important point to make is that there is a progression from a) to g) above. This is not only a progression in:

Severity of Action

Nuisance to the Driver

Severity of consequences if the action taken is mistaken, i.e. there is an innocent explanation.

The general principles for issuing a penalty or fine could be summarised as:

There must be a reasonable audit trail for collection, transmission and storage of the evidence. This would include the appropriate encryption, authentication and error correction techniques.

The evidence gathered shows unambiguously that a violation has happened, and that there can be no innocent or alternative explanation for the evidence presented.

RUC penalties are usually treated as violation of a civil regulation, and so in theory the scheme operator is only required to prove their case “on the balance of probabilities.” In practice, adjudicators have erred on the side of caution, and the requirements for the burden of proof is in practice close to that of criminal offences (e.g. speeding) which need to be proven “beyond reasonable doubt.” It is very difficult to name the safeguards that can be relaxed for the lower burden of proof.

IVE Security

Prevention of fraud relies greatly on the intrinsic security of the IVE 12. Therefore the difficulty of defrauding the system may to some degree depend on the minimum security standards agreed for the IVE 12. It seems likely that this would require a “trusted element” (SIM card) amongst other security measures.

Thin/Smart Client IVE

IVE 12 may use either a ‘thin client’ or ‘smart client’ approach. Each approach offers different opportunities and problems in compliance checking and enforcement.

Assuming any TDP scheme would be very wide area, if not national, it is probable that almost all national vehicles that are not exempt will be equipped with IVE 12.

This means that most casual users will probably be non-national vehicles. One could envisage scenarios where for example a scheme was purely for England, and Scottish, Welsh and NI vehicles might also be casual users, but the most likely, and most problematic casual users are likely to be non-UK vehicles.

There are a number of approaches that could be taken to charging casual users, for example:

Exempt foreign vehicles from the scheme. For example the Dutch are proposing exempting all non-Dutch vehicles, except non-Dutch HGVs. This approach may have political acceptability problems. From an enforcement viewpoint, this is the easiest solution, and has no issues.

Compel all casual users to have some sort of OBE (maybe a ‘lightweight’ version that they can install on a temporary basis). From an enforcement viewpoint, this approach raises a number of questions around the security and information available from a “lightweight” and temporary OBE. The issues would not only be technical, but also procedural and logistical, with the speed of information processing potentially being an issue. The recent Slovakian experience is a case-study in what can go wrong in this area!

Allow casual users to pay a flat “day rate”. This has the benefit of simplicity, both conceptually for the user, and also in terms of enforcement. A simple VRM lookup against a list of paid-up users is all that is required. It is very akin to how the London Congestion Charge operates at the present. It has the disadvantage of not giving any incentive to use the less congested times or places, and also disproportionally penalises low mileage users. If there were a large number of such vehicles, it may begin to frustrate the aims of the scheme.

As above, but allow the user to buy a permit for specific routes, areas or sectors. To some degree this is the approach taken in Germany. Slightly more complex than c) from an enforcement viewpoint, but not many major issues.

Allow casual users to declare a mileage per day from odometer readings. A politically more acceptable solution, but an enforcement nightmare. The only cross-reference is a minimum distance check from enforcement sites, and this can only be checked with an exit declaration. For a non-UK vehicle they may have left the country by this time.

This is not an exhaustive list, but is intended to make the point that different casual user schemes have very different enforcement issues, and as casual users are less likely to be familiar with the system, and are also harder to trace, enforcement should be one of the prime factors when setting up a casual user scheme.

Compliance Checking and Privacy Requirements

One of the major public concerns of a TDP tolling system is privacy. With every vehicle 10 being equipped with IVE 12, there is obviously the potential to misuse vehicle tracking data. This has been a major public concern and indeed some politicians have expressed concern as this aspect of such a scheme.

COLLECTING DATA—the DriveSync™ or Smartphone GPS antenna in the vehicle receives signals from the Earth's system of satellites and passes this positional data to the DriveSync™ telematics hub for processing, storage and management.

TRANSFERRING DATA—At regular predefined intervals, the DriveSync™ telematics hub uses cellular wireless networking to seamlessly upload (transfer) the accumulated encrypted (256 bit AES) trip data to the DriveSync™ server for compiling into a variety of reports and maps.

VIEWING DATA—Usage reports and charges are viewed on a secure and password-protected Web Portal,

The DriveSync Telematics platform consists of the following major functional components:

DriveSync On-Board Unit (OBU/IVE 12)—a device installed in road user vehicle which is responsible for collecting data from a number of sensors and interfaces (GPS, accelerometer, anti-tampering, OBD II) and delivering it to the back office system via wireless link (GSM/GPRS, WiMax or other). A smartphone can be programmed to do the same.

DriveSync Telematics back office module responsible for communication with OBU, as well as all aspects of driving data processing, including: trip generation, GEO coding, event handling, driving reports generation.

Charging Rule Engine responsible for charging data generation.

Charging System module responsible for charge object management, charge calculation and processing, payment processing and revenue sharing.

Data Exchange Interface which handles integration with 3rd party systems and components;

Road Charging Web Portal providing all stakeholders with a user friendly web-based GUI allowing them to access data and features provided by the DriveSync Telematics system. The stakeholders access to the information is regulated in according to their authorization level based on security model configuration;

Real-time charge reporting and display module. This module allows the user to keep track of road charges as they incur and accumulate. The module can be implemented on an in-vehicle unit, smartphone, or other devices such as desk computers, laptops, notebooks, etc.

Identification module with short distance wireless capabilities to enable compliance enforcement.

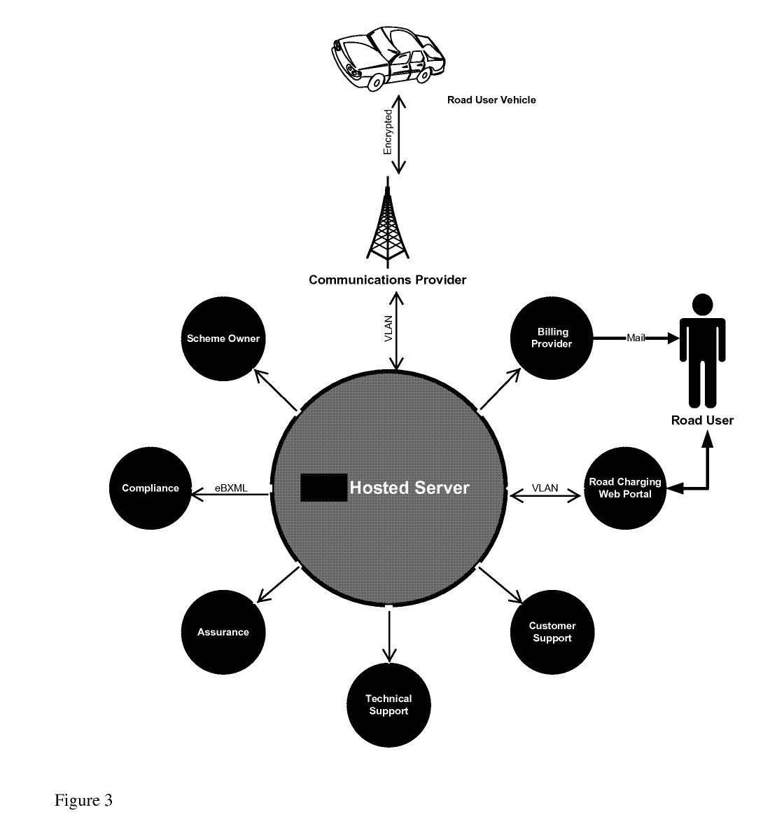

The major components of the system are shown in FIG. 4.

The back office solution provides the following main functionality:

Road User Services

Collection of driving data from DriveSync™ OBU/IVE equipped vehicles, including:

Trip information;

OBD II data (vehicle diagnostic trouble codes, alerts, Environmental reports, odometer, VRM)

3-axis accelerometer data (anti-tamper/anti-fraud, automatic crash notification, GPS augmentation)

Event-based data such as: Automatic Vehicle Location (AVL) ping, GEO fence zone crossing event, etc.

User Care web portal providing RUSP customer service and support group with a UI offering the following functionality:

New user registration

User profile management;

Payments & Credits management interface;

Invoice, settlement and usage reports;

User Self-Care web portal providing road user with access to the following functionality:

Profile management;

Access to electronic invoices;

Payment interface;

Settlement report;

Driving and service usage reports;

Charging Services

Price plan management through web-based portal:

Schema management

Charge Object management;

Charge Class management;

Charge and payment processing

Charge calculation:

Rating

Billing

Invoicing;

Automated payment settlement:

Payment collection

Revenue sharing;

Assurance Services

Assurance reports and KPI's available through web-based GUI and in a form of automated periodic data feed;

Reports available to various stake holders through web-based portal and in a form of automated periodic data feeds:

Usage reports;

Charge reports;

Exception reports;

Settlement reports;

Supporting Services

Driving data collection and processing;

New Scheme introduction and Scheme management;

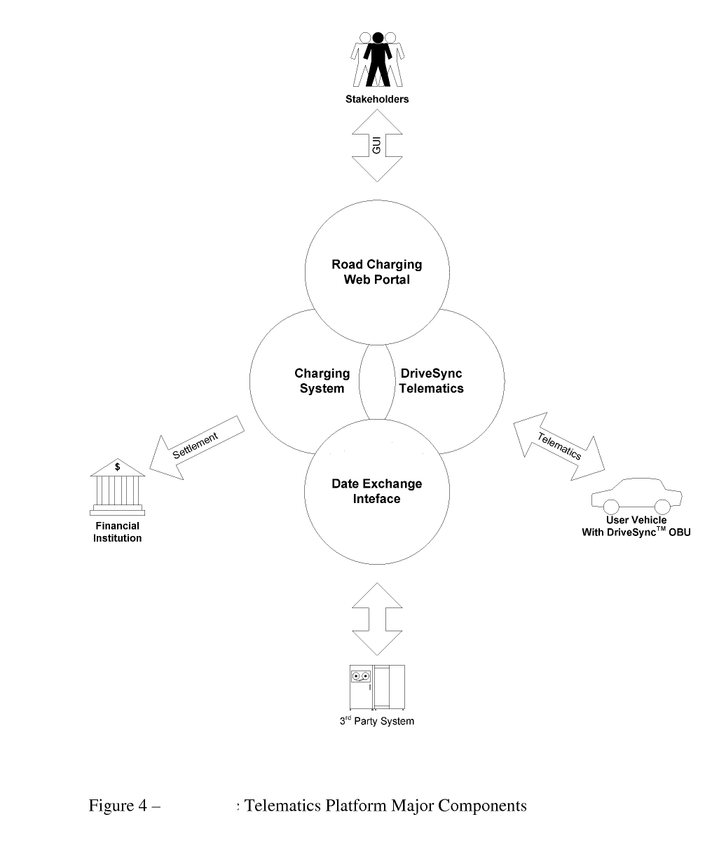

The DriveSync Telematics Platform Data Flow is shown in FIG. 5.

The DriveSync Telematics Platform Overall Architecture

The back office platform handles communication with DriveSync™ On-Board Units (OBU) installed on road user vehicles. The communication with OBU consists of the following types:

Driving data collection (GPS tracking, acceleration, etc.);

Diagnostic data collection (OBD II);

Event handling (tamper events, power loss, GEO-fence breach, etc.);

Device configuration (device profile configuration, GEO-fence setup, etc.);

Interactive features (Automated Vehicle Location (AVL), emergency assistance, etc);

Over-The-Air (OTA) device firmware update;

Device communication is bi-directional. The uplink is used to deliver driving data, diagnostics and events to the back office server as well as to deliver response triggered by an interactive feature. The downlink is used for device management and configuration, firmware update and to send interactive feature requests.

Data collected from DriveSync™ OBU by the DriveSync Telematics server is persisted in database and, depending on data type, guided to particular data processing module. For example: collected driving data is used for trip and driving report generation. Generated trip logs and driving reports could be later accessed by all relevant stakeholders (road users, RUSP Customer Support) via web-based GUI (Road Charging Web Portal). Collected driving data is also guided to Charging Rule Engine for charge generation.

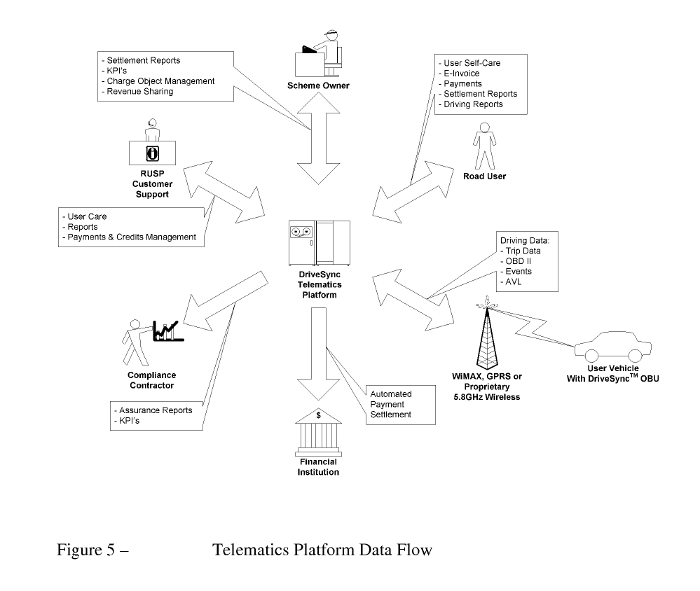

The DriveSync Telematics Platform Architecture Diagram is shown in FIG. 6.

The Charging Rule Engine generates charges based on collected driving data and a set of Charging Objects (Boundaries and Roads) defined by Charging Schemes. Generated charges are passed to the Billing System Module for charge rate calculation, electronic invoice generation and payment processing.

The Billing System module calculates charges based on defined Price Plan. The Price Plan consists of one or more Billing Schemes, each scheme containing a set of Charge Classes with respective rates and rate factors for defined Vehicle, User and Time Classes.

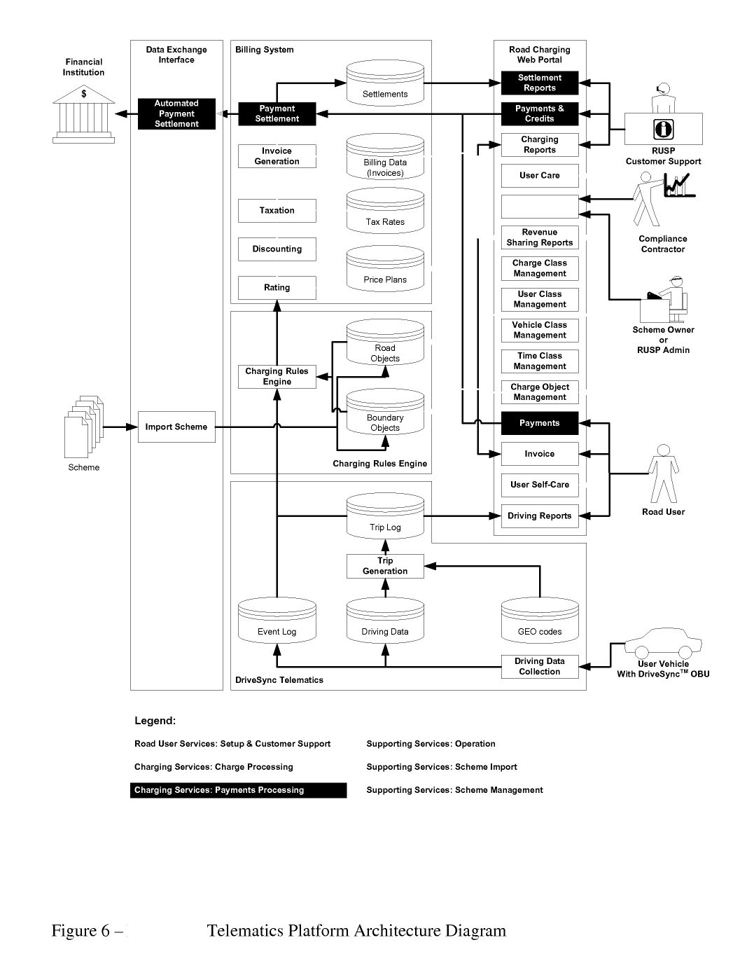

Example Charging and Billing Schemas are shown in FIG. 7.

Management of Price Plan as well as Charge Scheme is done through the DriveSync Telematics platform Road Charging Web Portal and potentially could be delegated to Scheme Owners. New Charge Scheme could also be imported into the system via scheme import facility.

In addition to charges the Billing System module also performs tax and revenue sharing calculations. Based on pre-defined accounting periods, Billing System module will generate electronic invoices, payment settlement requests and revenue sharing records. Payment settlement requests are handled by the Automated Settlement module which performs payment collection activities via 3^{rd} party financial institution. For the Road Pricing Demonstration Project, payment settlement and revenue sharing will be done by a means of a simulated system, representing a hypothetical financial institution.

Electronic invoices as well as settlement and revenue sharing reports will be accessed by respective stakeholders via Road Charging Web Portal.

The Road Charging Web Portal offers wide range of functionality to all major stakeholders, specifically:

Road Users

User Self-Care

Electronic Invoice Presentation

Settlement Reports

Driving (Usage) Reports

Payment UI

RUSP Customer Support

New User Registration

User Care

Reports

Credit & Payment UI

Compliance Contractor

Assurance Reports

KPI Dashboard

Scheme Owner

Settlement/Revenue Sharing Reports

Exceptions Report

KPI Dashboard

Charge Object Management

Charge Class Management

User Class Management

Vehicle Class Management

Time Class Management

Information access through Road Charging Web Portal is regulated based on Role Based Security (RBS) model. The RBS model defines which features offered by the portal could be accessed by each stakeholder type.

The Telematics Communication and Data Collection

Data communication between OBU/IVE 12 and the back office server is based on a TCP protocol. In terms of security, the first layer of protection is typically handled by a Virtual Private Network (VPN) between communication provider (such as GSM/GPRS provider) and the back office platform. The second layer of protection is data encryption which is part of the communication protocol. The encryption is based on AES-256 standard.

The Telematics Back Office Platform Network Diagram

Telematics back office platform has been designed from the ground up as a highly available and fault tolerant system [CAP079]. When the platform is deployed in production environment, it ensures at least N+1 level of fault tolerance, i.e. no single point of failure, every system component has redundancy.

The back office platform resilience is ensured by operating environment as well as application design.

The system utilizes exiting wireless networks such as GPRS, 3G, LTE and Wi-Fi for data transmission. Data frequency transmission can be configured so as to manage real-time billing and data transmission cost. When not in wireless coverage area, all driving information is still stored, but would only be transferred when in coverage.

Data Pulls—the in-vehicle device 12 firmware is programmed to send data at set times/events during the day and as such reduce the file size and need to pull bigger files on a weekly/monthly basis. The firmware on the IVE 12 can be changed at any time to re-program data pulls, or to upgrade functionality on the device.

Private Road User information and/or data transfers will be accessible to the relevant third parties through a custom web portal, or pre-defined reports transferred through secure channels. Approved program stakeholders will access the Road Charging web portal over HTTPS protocol, which requires authentication and provides encrypted communication. All data exchanged will be encrypted using a registered SSL certificate. This process ensures that only authorized parties are able to access the sensitive information. Furthermore, several network and system monitoring tools will detect intrusion and monitor the system for suspicious activities.

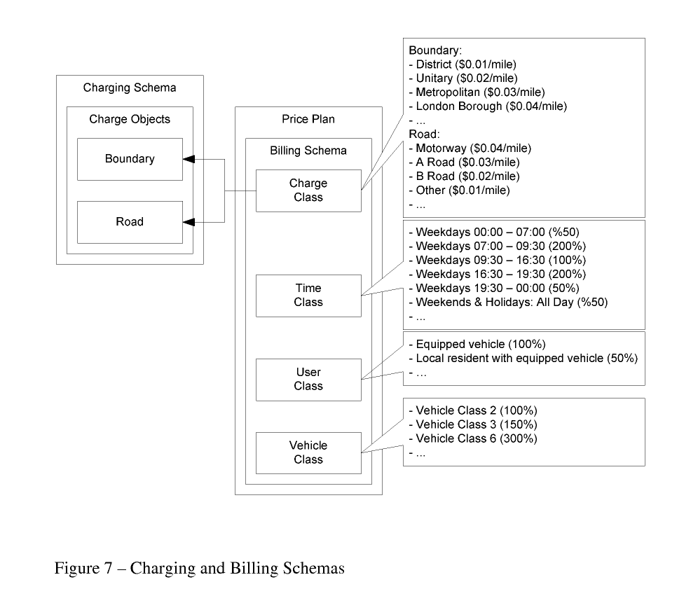

Access to the secure Road User Personal Information through the secure web portal, shown in FIG. 8, is an optional service. Optionally, RU Personal Information will be transferred in batch file nightly to the Scheme Owner.

Customer Support Services

The system will present the detailed trip information for all trips taken on a daily basis, with the associated details. The Road User will have two views to review the data and be able to quickly note trips that they want to dispute/contest. The driving data will be pulled up once per day, at various times depending upon the individual RU driving and nightly garage pattern (i.e. covered garage out of GSM coverage)

For each trip which generates any form of charge record, the main trip listing would be noted as a ‘chargeable trip.’ By then clicking on the icon denoting the chargeable trip, or switching views to the Billing module, the user would be able to see the details of the billing that affected that trip. In addition the user could click on the appropriate navigation icon to display a Google map that would show the trip from start to stop.

If after reviewing the data, the map, and the overlay of the charging scheme the RU wanted to dispute the charge, they could simply indicate so by clicking a ‘dispute’ box next to the trip. The box would have a generated tracking number to identify the trip being contested.

This would allow the user to input a descriptive statement on what was being disputed and why. After review of statement and indicating confirmation, this would generate a confirmation email to the client noting the Dispute had been received, no details in the email, just confirmation and an expected resolution expectation (timing) or follow-up. At the same time a report to customer service to review and respond is generated which would be tracked against KPI's for customer service delivery and response to Dispute Inquires. The email received in customer service would contain the applicable trip record number to establish an appropriate audit trail.

If the user did not review the trip information BEFORE the statement was generated, once they reviewed their statement they would come back to the secure web site and select the appropriate box for Dispute Record. This would allow the RU to enter the appropriate information (statement period, trip number, unique trip identifier, and dispute statement) so that customer service could follow-up and resolve. An email confirming receipt of the Dispute request would be sent and the request would be sent to customer service for resolution and response. The time period for accepting disputes before being closed would be one month (30 days from receipt of billing notice).

Any disputed charge records which were incorrectly generated would be reconciled with the Scheme Owner to ensure any false charge records would meet established KPIs.

As a process to regularly record the actual odometer, the system would receive information in two ways; with our connection directly to the vehicles computer system (through the OBDII connection), for most cars (2002 & newer) we can read the odometer directly from the car; the second system would ask for periodic updates from the Road User as to the actual mileage showing on the cars odometer. These update requests would occur as pop-ups after a RU has signed onto the secure portion of the reporting web site.

The Road Users would receive their monthly incentive of Loyalty points for their weekly review of the billing statement and input of their odometer. This input can be verified against actual readings IMS pulls from the OBDII port where available.

Charging Processing

The system uses two redundant systems for reporting distance traveled—one based on GPS positional readings and the other using vehicle odometer readings from the On-Board-Diagnostic (OBD II) Adaptor. Not all vehicles will require a redundant OBDII system for measuring distance traveled but it is expected that the percentage using this feature will validate the accuracy of the overall system on an ongoing basis. When available the system will combine GPS with odometer to enhance accuracy.

Calculating Distance Traveled Using GPS Readings:

Vehicle position is derived from the latitude and longitude reported by a GPS receiver residing on the OBU. The GPS receiver reports the latitude and longitude of the vehicle once per second to an accuracy of 5 m. When the GPS receiver first acquires or reacquires the vehicle's position, the latitude and longitude of this position are recorded. This recorded latitude and longitude becomes the reference vehicle position.

The OBU embedded software then tracks the vehicle through a virtual grid of approximately 10 m×10 m: Latitude (North-South) 11.1 m and Longitude (East-West) 6.1 m. These are consolidated into ‘zones’ measuring 12.2 m East-west and 22.2 m North-South using the coordinates reported by the GPS receiver. When the vehicle passes through one of these zones in a north, east, south or west direction or some combination of these directions, a record is stored containing an incremented value representing the relative change in vehicle position. The new reference position becomes the south-east corner of the new zone entered.

In addition, a running total of the distance traveled by the vehicle from the time of the last recorded position to the time at which the zone change is position-detected is accumulated by the OBU using the data derived from the GPS receiver.

When the vehicle position changes such that it intersects a zone boundary in any of the directions indicated above, another record is stored in a similar fashion with the reference vehicle position updated appropriately.

This recorded data representing the vehicle's position is transferred from the OBU to the server applications and decoded to recover distance traveled by the vehicle for reporting purposes. Specifically, the recorded accumulated distance based on positional changes at the time of zone crossings is used to calculate the total distance traveled by the vehicle.

Self Validation of Distance Traveled using OBD II Vehicle Odometer Readings:

The OBD II interpreter used by IMS Inc. gathers date from the vehicle odometer to provide a report of the distance traveled by the vehicle independent from the GPS receiver. This distance reported by the OBD II interpreter will be used to validate the distance traveled measured by the GPS-based applications.

Vehicle position is derived from the latitude and longitude reported by a GPS receiver residing on the OBU. The GPS receiver reports the latitude and longitude of the vehicle once per second. When the GPS receiver first acquires or reacquires the vehicle's position, the latitude and longitude of this position are recorded. This recorded latitude and longitude becomes the reference vehicle position.

The OBU embedded software then tracks the vehicle using the coordinates reported by the GPS receiver. As the vehicle passes to the north, east, south or west direction or some combination of these directions, a record is stored containing an incremented value representing the relative change in vehicle position. The new reference position becomes the south-east corner of the new zone entered.

In addition, a running total of the distance traveled by the vehicle from the time of the last recorded position to the time at which the 20 meter change is position detected is accumulated by the OBU derived from the data reported by the GPS receiver.

When the vehicle position changes by another 20 meters in any of the directions indicated above, another record is stored in a similar fashion with the reference vehicle position updated appropriately.

This recorded data representing the vehicle's position is transferred from the OBU to the server applications and decoded to recover distance traveled by the vehicle for reporting purposes. Specifically, the recorded accumulated distance between 20 meter changes in vehicle position is used calculate the total distance traveled by the vehicle.

The OBD II interpreter used by IMS Inc. provides a report of the distance traveled by the vehicle independent from the GPS receiver. This distance reported by the OBD II interpreter could be used to validate the distance traveled measured by the GPS-based applications. [CAP015] This can be used by the Compliance and Assurance contractors to validate the actual distance traveled, against the calculated GPS position.

Driving data captured by OBU 12 is uploaded to Telematics server for further data processing. The Telematics module performs several data processing steps, including trip generation and reverse GEO coding.

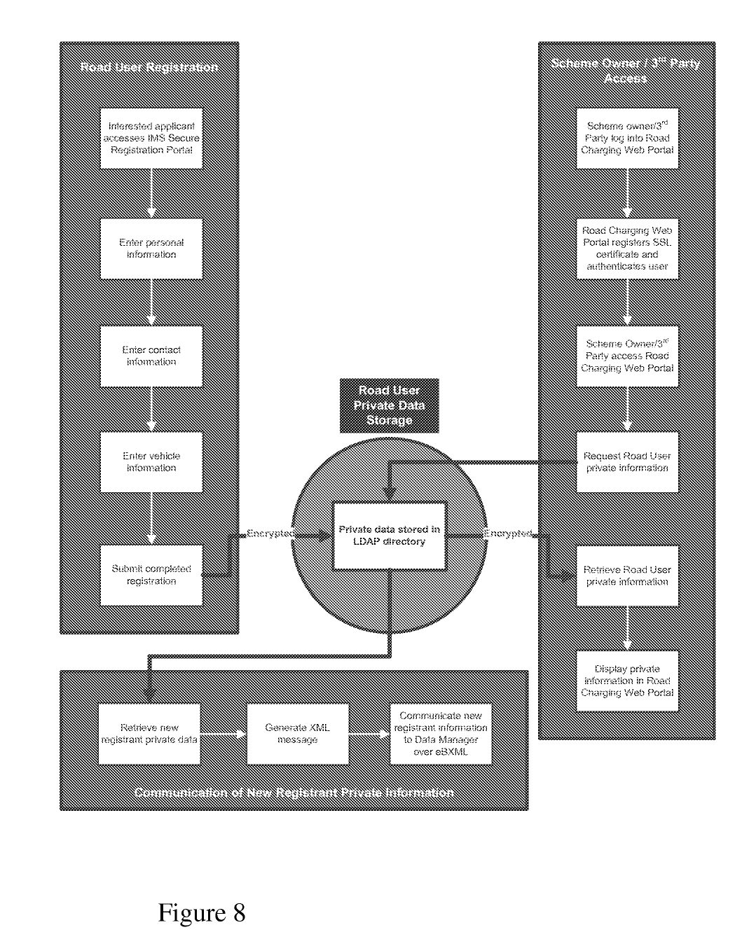

Example Charge Processing is shown in FIG. 9. Based on collected driving data and Charge Objects (Boundaries and Roads) defined by Charging Schemes the Charging Rule Engine generates chargeable events [CAP014] corresponding to various driving activities, such as: distance driven within a chargeable object [CAP016], entry charge [CAP020], exit charge [CAP021], etc.

DriveSync OBU reports driving data (such as driving distance) in metric units, however, Charging Rule Engine has capability to convert units to a different system, in accordance with the UK derogation on road signs for example [CAP017].

Generated chargeable events are passed to the Billing System Rating module which calculates charges based on defined charge Classes and applies factors to the nominal tariff based on defined user, vehicle and time classes (Discounting) [CAP018, CAP019]. The Rating module will also handle driving distance rounding [CAP025].

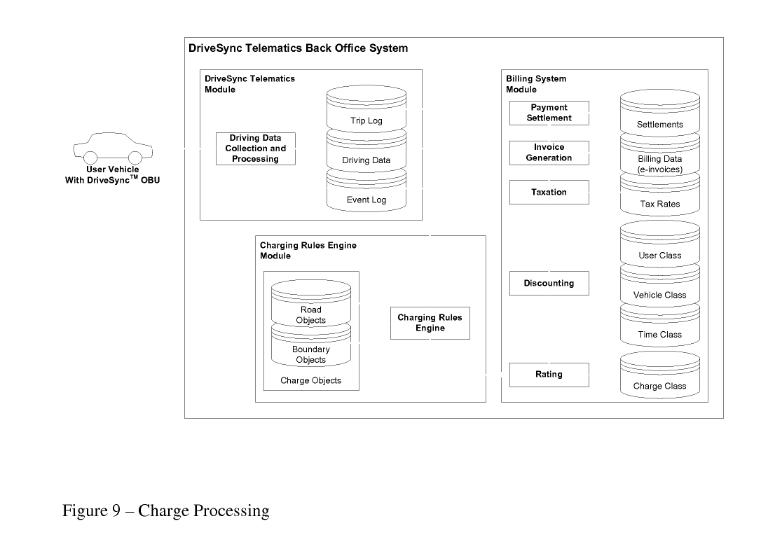

Example Charging and Billing Schemas are shown in FIG. 10. The requirement to handle a minimum distance for charging [CAP022] will be implemented by means of stepped rating. Stepped rating allows applying variable rates based on the amount of consumed units. For example: rate distance at $0.01/mile for initial 10 units (miles), then change rate to $0.02/mile for a number of units (miles) between 10 and 50 and then use rate $0.03/mile for anything above 49 miles.

Charge records generated by the Rating module will contain the following information [CAP024]:

| Attribute | Description |
|---|---|
| Charge record ID | Unique numeric charge record identifier |
| Road User account ID | User account responsible for the charge |
| OBU ID | OBU associated with the charge |
| Scheme ID | Scheme associated with the charge |
| Charge Object ID | Charge Object associated with the charge |
| Charge Class ID | Applied Charge Class |
| Time Class ID | Applied Time Class |
| User Class ID | Applied User Class |
| Vehicle Class ID | Applied Vehicle Class |
| Start Date | Event start date and time |
| End Date | Event end data and time |
| Distance | Reported distance traveled within the |
| | Charge Object |
| Distance Charge | Calculated distance charge |
| Entry Charge | Entry charge amount |
| Exit Charge | Exit charge amount |
| Time Class Factor | Calculated time class factor (adjustment) |
| User Class Factor | Calculated user class factor (adjustment) |
| Vehicle Class Factor | Calculated vehicle class factor (adjustment) |
| VRM | Anonymized Vehicle Registration Mark¹ |

¹Optional reference field will be used to store VRM.

Taxation engine performs tax calculation for all charges produced by the Rating module. All charge records are persisted in database as billing data which is used for electronic invoice generation as well as for various reports.

Billing data is also used for payment settlements generation and for revenue sharing. Based on pre-defined accounting periods, the Billing System module will generate electronic invoices, payment settlement and revenue sharing records. Payment settlement is handled by the Automated Settlement module which performs payment collection activities via 3^{rd} party financial institution. For the Road Pricing Demonstration Project, payment settlement and revenue sharing will be done by a means of a simulated payment processing system, representing a hypothetical financial institution.

Electronic invoices as well as settlement and revenue sharing reports could be accessed by respective stakeholders via Road Charging Web Portal, or files transferred by XML.

The Billing system module does offer a capability to calculate charges in pounds Sterling.

The Charging Rules engine will define the charge to be applied to each Charge Class which could consist of one or both of Nominal tariffs applied to Reported Distances, or as modified by the appropriate factors for use, vehicle and time class, and/or for Entry/Exit charges, which may be dependent on the user, vehicle and time classes of the event.

Immediate notification of the RU's of various GPS based Location Based Services would be done by the RU signing up to receive the notification and agreeing to use their driving information for the purposes of notification. This would be done by email or SMS alerts to the RU's registered cellular phone. This would allow the user to alter their trip if necessary, and as a reminder of the charge. This notification could be turned on/off at the RU's choosing through the secure web site.

One of the main principals of the proposed system is to show the value to consumers for using other Telematics functionalities, so consumers will want to put such technology in their vehicles. As such, as part of the sign-up process to participate in the initial program, consumers will be notified and give permission to share their driving data in exchange offers and LBS marketing information. Consistent with Privacy Policy, consumers can withdraw their consent at any time and be opted out of the program as well.

As part of our reporting suite, the system offers a peer reporting tool to show the RU the comparison of their driving habits against their peers in the demonstration program. This is currently done for attributes such as; speed, time of day, aggressive driving behaviours (acceleration/deceleration), cornering, anticipation. We show a bar graph of the mean position with respect to the various attributes and then how the individual is placed on ‘bell curve’ of all participants. The system then displays content titles on the right navigation of the reporting suite that are dynamically driven with respect to the implications of the various driving behaviours shown on the left. The concept is to highlight to drivers the implications of their driving without the ‘gotcha’ aspect of the reporting.

The implications of speeding over the Posted Speed Limit (PSL), such as traffic fines, demerit points, accidents, higher insurance rates, repairs etc would be shown.

For the billing module we would add the weekly billing attribute and allow a RU to see how they compared against other users. The content on the right navigation would then allow the user to see what options or hints that could be supplied to lower their weekly (simulated) bill.

The system will provide a capability to supply Charge Statements to each Road User for all charges incurred in all Schemes.

Each Charge Statement should contain the following:

Time period which the statement covers

Date, time and Schemes where the charges were raised

Total Reported Distance and distance travelled in each Scheme

Total charge liabilities incurred for each Scheme

Total entry and exit charges incurred in each Scheme

Adjustments and balances from previous statements

The system will offer as an optional capability the option of itemized detail in a Charge Statement, such as individual Charge Record details or analysis of Charge Objects over time, time classes during accounting periods, etc.

In addition, the scaleable nature of our hosting system AND the billing module for charging processing allows the software to encompass up to 100,000 users per implementation (additional hardware necessary). While not needed for this project the Enterprise architecture and capacity planning that has been encompassed in our billing module and charge processing modules allow for this flexibility.

Notification through in-vehicle devices or smartphones will allow RU's to know in real-time the implications of traveling on various roads or cordon areas as they drive. The system will push down to our IVE the parameters for the Charge Objects and hence be able to notify and display the current charges for that specific trip (estimated only) right on the device display.

Registration Process

For each relevant field, an information bubble is located beside the field to allow the user to understand why the information is being requested and how it will be used. This also builds trust as the disclosure level is usually higher than most data collection or registration sites that put usage statements only in legal copy. A multi-step registration process to collect the necessary data also allows for a greater completion percentage of those consumers interested. After the data has been collected a confirmation of data is requested which allows the user to review and or edit data that has been input. Upon completion, a screen message setting next step expectations is displayed and emailed to the interested party.

Once the geographic location, vehicle information has been manually reviewed, a daily file will trigger emails back to the individual and to our installation partner confirming acceptance and setting expectations as to contact and next steps. Each email has the necessary contact telephone numbers listed on it as well as an email address for inquires or questions on the program. Any inquiries are tracked for development of reporting for timeliness and assurance and compliance. All calls are to be recorded with the necessary disclaimer in advance of any conversations—this is for assurance, compliance and training purposes.

Administrative Functions

To offer a better user experience the portal will allow participants to manage their account and make any administrative changes to their profile. Through the portal, the participant can:

Register a new vehicle and request an appointment to have a device installed

Request an appointment to have the device exchanged from one vehicle to another

Edit their personal/vehicle information

Report accidents that may have affected the proper functioning of the device

Withdraw from the program and arrange to have the device de-installed

View the various reports provided in the consumer offering

Configure the numerous features offered in the consumer program

Consumer program participants subsequently recruited into the road user demonstration will, in addition, be able to access reports specific to their involvement in the demonstration, such as billing, mileage reports, etc.

Dispute Process

Enabling an easy Dispute process and transparent resolution process, for any billing charges, or any other customer interaction is necessary to build credibility in the system and provide for a superior customer experience.

The user, while online verifying the individual charge records, can simply click on an input box next to the charge summary. This allows a dynamic record to be created with the relevant charge data reference number attached, and an opportunity for the RU to input commentary to explain why they are disputing the charge. Upon sending the Dispute record, the email tracking system logs the Dispute and will track responses and response time for KPI measurement.

The system gathers positive consent (versus implied consent) to use personal and driving information to receive value-added marketing offers and services. In addition, to become a Road User (RU), they will have to review and make a positive consent action to agree to the Confidentiality Agreement and Consent form as a Road User.

The system takes extra steps to ensure strong data protection for Personal Information. This is accomplished by separating the driving data/trip data, from the Personal Information. In this way, if the system is ever successfully hacked, the person would only have access to driving data that couldn't be attributed to any individual.

Measures Ensuring Data Security Include:

Implemented and enforced network security policies (firewalls, VLAN's, VPN's, access control);

IMS DriveSync Telematics back office platform is based on a 3-tier architecture providing enhanced security by physically separating database, application and Web front-end layers;

DriveSync OBU and DriveSync Telematics back office platform communication is encrypted (AES-256 encryption);

DriveSync OBU and DriveSync Telematics back office platform communication is handled over a VPN;

Various stakeholders access Road Charging Web Portal over HTTPS protocol, encrypted using registered SSL certificate;

Private Road User information is stored outside of the main database in LDAP Directory, driving data stored in the main database is depersonalized in order to enhance privacy protection;

Network and system monitoring tools are used for intrusion detection as well as to watch for suspicious activities;

Charge Processing Services

Estimations for the average number of charge records in Scheme 1 are based on the following assumptions:

On average 80% of all Road Users engaged in the demonstration project are active users;

An active Road User travels twice (driving to work and back) across 2 districts within 24 hours on average, leaving one district and entering another (see diagram below);

All districts have associated distance and event based charges;

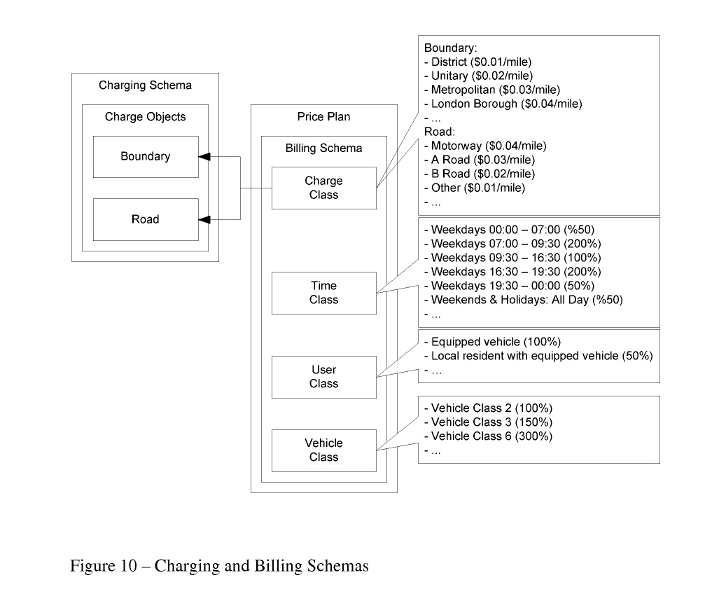

Scheme 1 Travel Pattern is shown in FIG. 11. Based on the assumptions listed above, each of the users will produce two distance-based charge records and four event-based Charge Records (two entry and two exit records) per 24 hours.

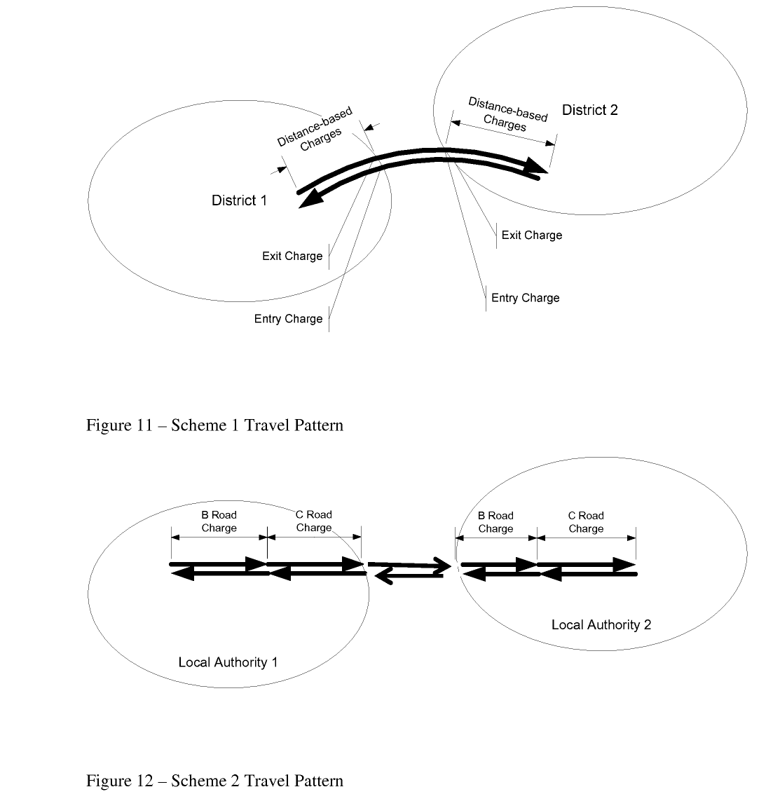

Scheme 2 Travel Pattern is shown in FIG. 12.

New Scheme Introduction

Telematics platform supports multiple charge classes as defined by the “Scheme Template Guidance” document. Requested charge classes, time classes, user classes and vehicle classes are supported by the DriveSync Telematics platform Billing Module.

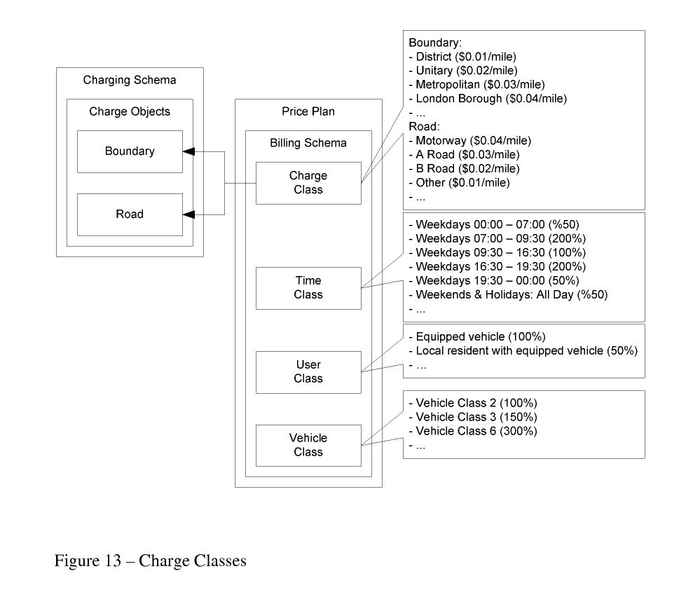

Example Charge Classes are shown in FIG. 13. The Telematics Platform does not imply any limitations regarding the number of supported Schemes other than system performance. The anticipated number of Schemes and Charge Objects used in the Road Pricing Demonstrations Project should not be causing any performance issues. The Telematics back office platform is designed as a horizontally scaleable system and takes advantage of clustering on all layers of the application which allows managing platform capacity growth in a cost efficient manner.

The solution can support up to Max (currently 10) Schemes operating simultaneously within each Demonstration. Each Scheme to be tested individually and working in combination with other Scheme Templates provided.

What is claimed is:

1. A system for assessing transportation infrastructure usage comprising:
an on-board unit installed on a vehicle, the on-board unit configured to obtain one or more parameters describing vehicle usage and location; and
a server receiving the one or more parameters from the on-board unit to assess transportation infrastructure usage by the vehicle.

2. The system of claim 1 wherein the parameters include driving events, number of vehicle occupants, environmental impact, and infrastructure impact.

3. The system of claim 1 wherein server is configurable to assess the transportation infrastructure usage before and/or after deployment to assess usage using static or dynamic rules.

4. The system of claim 1 wherein the one or more parameters include idling time, emissions, mileage, time of day, vehicle mass, location, road class, vehicle class, and defined zones.

5. The system of claim 1 wherein the transportation infrastructure usage information is transformed into a usage fee.

6. The system of claim 5 wherein the usage fee is delivered to an owner of the vehicle by generating transportation infrastructure usage summaries, detailed validation data, and invoices/bills with objective evidence to support each usage fee.

7. The system of claim 1 wherein individual usage information is validated using aggregate vehicle movement information, vehicle movement information from vehicles in close proximity to the vehicle in question, and/or infrastructure reference points.

8. The system of claim 6 wherein the server is configured to generate the usage fee based upon the lanes in which the vehicle travels.

9. The system of claim 8 wherein the server is configured to generate the fee based upon the total number of occupants within the vehicle.

10. The system of claim 8 wherein server is configured to generate the usage fee based upon time-varying parameters including traffic congestion peak times and recent traffic load estimates

11. The system of claim 8 wherein the location information is obtained from satellite and accelerometers.

12. A method for providing parking services including the steps of:
determining a resting location of a vehicle;
determining that the location of the vehicle is in a parking zone;
identifying the time and duration of the resting location of the vehicle within the parking zone; and
applying parking fee rules based upon the time and duration of the vehicle in the parking zone.

13. The method of claim 12 wherein the parking fee rules include a factor to encourage the use of mass transit.

14. A method of validating road usage compliance including the steps of:
automatically obtaining license plate details on restricted use lanes; and
cross referencing the license plate details on restricted use lanes against location data reported from the vehicle.
